(19) United States
(12) Patent Application Publication
(10) Pub. No.: US 2014/0324618 A1
(43) Pub. Date: Oct. 30, 2014

(54) RESTRICTING AN AUCTION TO ACTIVE BIDDERS BY EXCLUDING JUMPERS

(71) Applicant: DealDash Plc, Helsinki (FI)

(72) Inventor: William Wolfram, Helsinki (FI)

(73) Assignee: DealDash Plc, Helsinki (FI)

(21) Appl. No.: 13/963,838

(22) Filed: Aug. 9, 2013

Related U.S. Application Data
(60) Provisional application No. 61/816,521, filed on Apr. 26, 2013.

(51) Int. Cl. G06Q 30/08

(52) U.S. Cl. CPC G06Q 30/08
USPC 705/26.3

(57) ABSTRACT

A method of hosting an auction is disclosed. The auction has, for each specified time, a current highest bid value. The method includes receiving, from a first bidder, a first bid having a first bid value. The method also includes evaluating the first bid to a) determine that the first bid value exceeds the current highest bid value of the auction by at least a first minimum increment, b) determine that the first bid value is within a first price range, and c) determine that the first bidder has placed at least one previous bid, such that the at least one previous bid caused the current highest bid value to be increased by at least a first minimum total amount. The method also includes replacing the current highest bid value with the value of the first bid received from the first bidder.

### RELATED APPLICATIONS

This application claims a priority benefit under 35 U.S.C. §119(e), to U.S. provisional patent application Ser. No. 61/816,521, filed Apr. 26, 2013, entitled “Restricting an Auction to Active Bidders by Excluding Jumpers.” The foregoing application is incorporated herein by reference in its entirety.

### BACKGROUND

Auctions generally feature a group of buyers bidding on an auction offer. The Auction offer may be an item, a service, an opportunity, or anything else that may be auctioned. Typically, an auctioneer announces a current bid price, e.g., a highest bid or an initial expected bid, and requests higher bids from prospective buyers. The prospective buyers, bidders, enter bids in an attempt to have the highest bid—although usually with the secondary goal of not over-bidding. An auction may proceed until no one is willing to place a higher bid or until some other threshold event such as the termination of a pre-set period of time. Auctions may be held in person or remotely, e.g., by telephone or Internet, and bids may be public or private, as in a secret auction.

An auction may be held entirely online, e.g., using a website accessible via the Internet. A seller may place an auction offer on the website and allow bidders to place bids on the offer. Online auctions are generally terminated at a preset end time, with the highest bidder at the end time winning the auction. In a penny auction, all bids are increments by a fixed amount, usually by one penny. A bid usually postpones the end time by a certain period of time. Because a fee is usually charged for proposing a bid, bidders are the better off the fewer bids they end up proposing. This creates a free rider problem; it is a common tactic to bid only if no other bidder bids in order to avoid the fee. Free riders who enter an auction as late as possible and bid as few times as possible are called “jumpers”.

### SUMMARY OF THE INVENTION

Aspects and embodiments of the present disclosure are directed to systems and methods of hosting an auction. In general, a number of criteria may be established for refusing a bid in an auction. In some embodiments, one of the criteria may be two-part: i) the current benchmark has to be within a first price range, and ii) bid increments by the bidder placed within a second price range have to add up to less than a first minimum amount. In some embodiments, there may be a second two-part criterion: i) the current benchmark has to be within a third price range, and ii) bid increments by the bidder placed within a fourth price range have to add up to less than a second minimum amount. In general, an auction server may receive a bid from a bidder. The auction server may determine that the bid value exceeds the current benchmark by at least a minimum increment. The auction server may determine which criteria for refusing a bid are met. In some embodiments, if at least one criterion is met, a bid may be refused. If no criterion is met, the auction server may set the bid value as the new benchmark. The auction server may terminate the auction before receiving another bid from another bidder, and charge the last bidder the bid value.

At least one aspect is directed to methods of establishing a number of criteria for refusing a bid in an auction. In some embodiments, one of the criteria may be a two-part criterion: i) the current benchmark has to be within a first price range, and ii) bid increments by the bidder placed within a second price range have to add up to less than a first minimum amount. In some embodiments, there may be a second two-part criterion: i) the current benchmark has to be within a third price range, and ii) bid increments by the bidder placed within a fourth price range have to add up to less than a second minimum amount. The methods may include receiving a bid from a bidder proposing a bid value, determining that the bid value exceeds the current benchmark by at least a minimum increment, determining that the current benchmark is not within a first price range, determining that no other criterion for refusing a bid is met, and setting the bid value as the new benchmark. The method may further include receiving a bid from a bidder proposing a bid value, determining that the bid value exceeds the current benchmark by at least a minimum increment, determining that the current benchmark is not within a first price range, determining that at least one of the other criteria for refusing a bid is met, and refusing the bid. The method may further include receiving a bid from a bidder proposing a bid value, determining that the bid value exceeds the current benchmark by at least a minimum increment, determining that the current benchmark is within a first price range, determining that bid increments by the bidder placed within a second price range do not add up to less than a second minimum, determining that no other criterion for refusing a bid is met, and setting the bid value as the new benchmark. The method may further include receiving a bid from a bidder proposing a bid value, determining that the bid value exceeds the current benchmark by at least a minimum increment, determining that the current benchmark is within a first price range, determining that bid increments by the bidder placed a second price range do not add up to less than a second minimum, determining that at least one of the other criteria for refusing a bid is met, and refusing the bid. The method may further include receiving a bid from a bidder proposing a bid value, determining that the bid value exceeds the current benchmark by at least a minimum increment, determining that the current benchmark is within a first price range, determining that bid increments by the bidder placed within a second price range add up to less than a second minimum, and refusing the bid. The method may further include terminating the auction before receiving another bid from another bidder, and charging the last bidder the bid value.

At least one aspect is directed to systems comprising an auction server configured to establish a first two-part criterion for refusing a bid: i) the current benchmark has to be within a first price range; and ii) bid increments by the bidder placed within a second price range have to add up to less than a first minimum. The auction server may further be configured to establish a second two-part criterion for refusing a bid: i) the current benchmark has to be within a third price range; and ii) bid increments by the bidder placed within a fourth price range have to add up to less than a second minimum. The auction server may further be configured to receive a bid from a bidder proposing a bid value, determine that the bid value exceeds the current benchmark by at least a minimum increment, determine that the current benchmark is not within a first price range, determine that no other criterion for refusing a bid is met, and set the bid value as the new benchmark. The auction server may further be configured to receive a bid from a bidder proposing a bid value, determine that the bid value exceeds the current benchmark by at least a minimum increment, determine that the current benchmark is not within a first price range, determine that at least one of the other criteria for refusing a bid is met, and refuse the bid. The auction server may further be configured to receive a bid from a bidder proposing a bid value, determine that the bid value exceeds the current benchmark by at least a minimum increment, determine that the current benchmark is within a first price range, determine that bid increments by the bidder placed within a second price range do not add up to less than a second minimum, determine that no other criterion for refusing a bid is met, and set the bid value as the new benchmark. The auction server may further be configured to receive a bid from a bidder proposing a bid value, determine that the bid value exceeds the current benchmark by at least a minimum increment, determine that the current benchmark is within a first price range, determine that bid increments by the bidder placed within a second price range do not add up to less than a second minimum, determine that at least one of the other criteria for refusing a bid is met, and refuse the bid. The auction server may further be configured to receive a bid from a bidder proposing a bid value, determine that the bid value exceeds the current benchmark by at least a minimum increment, determine that the current benchmark is within a first price range, determine that bid increments by the bidder placed within a second price range add up to less than a second minimum, and refuse the bid. The auction server may further be configured to terminate the auction before receiving another bid from another bidder, and charge the last bidder the bid value.

In some embodiments, such criteria may be chosen that avoid situations where all possible bids would be accepted or all possible bids would be refused. For example, at the beginning of the auction, if a bid were to be refused if the bidder has not bid earlier in the auction, all possible bids would be refused. Also, if a bid were to be refused if, at a value of the current benchmark, bid increments by the bidder placed the first price range added up to less than a first minimum amount greater than the width of the first price range, all possible bids would be refused. In some embodiments, a bid may be refused if at least one criterion for refusing a bid is met. In some embodiments, a bid may be refused if a number of criteria are met.

In a penny auction, where every bid increment is a penny, the minimum amount to which the increments within a certain price range have to add up may as well be defined simply as a minimum number of bids. In a penny auction, a minimum of one bid would require bidding at all within the price range. In some embodiments, for at least some values of current benchmark, the minimum increment may be any value, however small, greater than zero.

In some embodiments, the upper bound of the first price range, referred to by the first criterion, may be infinity. In that case, the first part of the first criterion would be met at all values of the current benchmark equal to or greater than a certain milestone, the lower bound of the first price range. The lower bound of the second price range, referred to by the first criterion, may be zero. In that case, all increments by the bidder before the bid price reaches a certain milestone, the upper bound of the second price range, would be added up. The lower bound of the first price range may be higher than the upper bound of the second price range. All that is said above about the first criterion, and the first and second price ranges it refers to, may apply to the second criterion, and the third and fourth price ranges it refers to, as well.

In some systems, the server includes a physical computing device executing software instructions, which when executed, cause the physical computing hardware device to do the same. At least one aspect is directed to a system including an auction server configured to execute the methods. At least one aspect is directed to non-transitory computer-readable storage media storing processor executable instructions, which, when executed by one or more processors, cause the one or more processors to execute one or more of the methods described.

One embodiment is a method of hosting an auction. The auction has, for each specified time within an active timeframe of the auction, a current highest bid value. The method includes receiving, from a first bidder, at a first time within the active timeframe of the auction, a first bid having a first bid value. The method also includes evaluating the first bid to a) determine that the first bid value exceeds the current highest bid value of the auction corresponding to the first time by at least a first minimum increment, b) determine that the first bid value is within a first price range, and c) determine that the first bidder has placed at least one previous bid at an earlier time within the active timeframe of the auction, such that the at least one previous bid caused the current highest bid value to be increased by at least a first minimum total amount. The method also includes replacing the current highest bid value with the value of the first bid received from the first bidder.

Another embodiment is a system for hosting an auction. The system includes an auction server having at least one physical processor. The auction server is configured to receive, from a first bidder, at a first time within the active timeframe of the auction, a first bid having a first bid value. The auction server is further configured to evaluate the first bid to a) determine that the first bid value exceeds the current highest bid value of the auction corresponding to the first time by at least a first minimum increment, b) determine that the first bid value is within a first price range, and c) determine that the first bidder has placed at least one previous bid at an earlier time within the active timeframe of the auction, such that the at least one previous bid caused the current highest bid value to be increased by at least a first minimum total amount. The auction server is further configured to replace the current highest bid value with the value of the first bid received from the first bidder.

Another embodiment is a non-transitory computer readable medium encoded with instructions that, when executed on a processing unit, perform a method. The method includes receiving, from a first bidder, at a first time within the active timeframe of the auction, a first bid having a first bid value. The method further includes evaluating the first bid to a) determine that the first bid value exceeds the current highest bid value of the auction corresponding to the first time by at least a first minimum increment, b) determine that the first bid value is within a first price range, and c) determine that the first bidder has placed at least one previous bid at an earlier time within the active timeframe of the auction, such that the at least one previous bid caused the current highest bid value to be increased by at least a first minimum total amount. The method further includes replacing the current highest bid value with the value of the first bid received from the first bidder.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating an example environment for hosting an online auction;

FIG. 2 is a block diagram illustrating an example computer system that may be employed to implement various elements of the systems and methods described and illustrated herein, according to an illustrative embodiment;

FIG. 3 is a block diagram of an example system for hosting an auction;

FIG. 4 is a block diagram of a user interface to an online auction system;

FIG. 5 is a flow diagram illustrating a method of hosting an auction; and

FIG. 6 is a flow diagram illustrating a method of hosting an auction.

FIG. 7 is a screenshot illustrating a user interface to an online auction system.

### DETAILED DESCRIPTION

Following below are more detailed descriptions of various concepts related to, and embodiments of, methods of, apparatuses for, and systems for hosting an auction. The various concepts introduced above and discussed in greater detail below may be implemented in any of numerous ways, as the described concepts are not limited to any particular manner of embodiment. Although this disclosure focuses on web sites as exemplary hosts of auctions, alternative auction hosts may make use of the novel features described herein without departing from the scope of the invention. Examples of specific embodiments and applications are provided primarily for illustrative purposes.

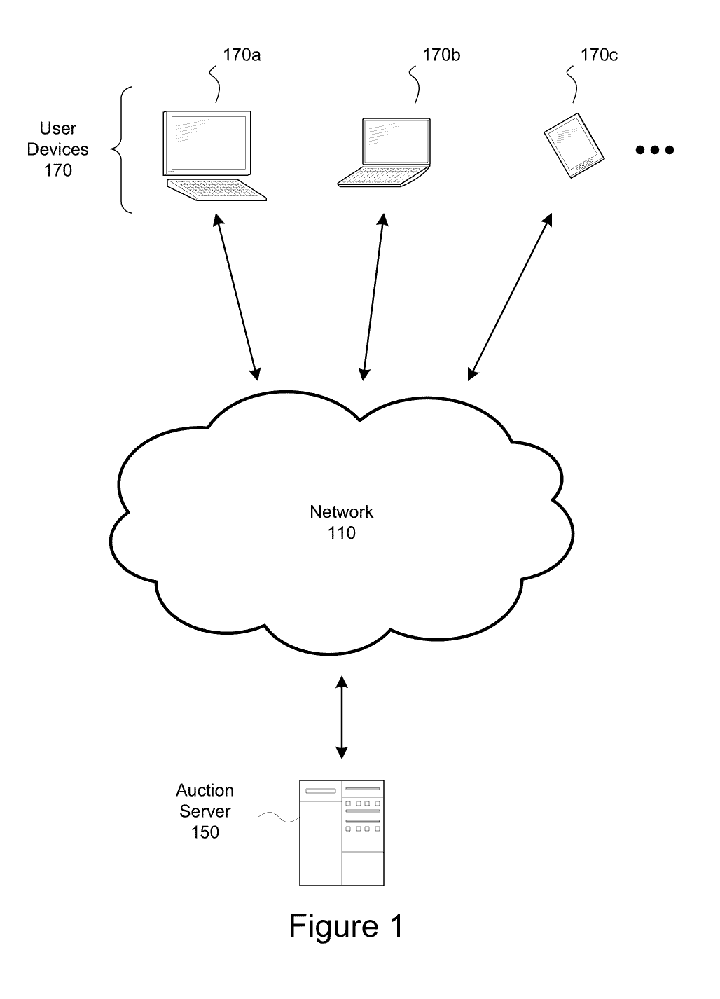

FIG. 1 illustrates an example environment for hosting an online auction according to an embodiment of the present disclosure. An auction server 150 is accessible to user devices 170 via a network 110, e.g., the Internet. The user devices 170 may be any device capable of accessing the auction server 150 via the network 110. For example, a user device may be a desktop computer 170a, a laptop computer 170b, or a mobile device 170c such as a smart phone, tablet, or digital pad.

The network 110 can be a local-area network (LAN), such as a company intranet, a metropolitan area network (MAN), or a wide area network (WAN), such as the Internet and the World Wide Web. The network 110 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some embodiments, there are multiple networks 110 between participants, for example a smart phone 170c typically communicates with Internet servers via a wireless network connected to a private corporate network connected to the Internet. The network 110 may be public, private, or a combination of public and private networks. The topology of the network 110 may be a bus, star, ring, or any other network topology capable of the operations described herein. The network 110 can be used to access the auction server 150 by at least one user device 170, such as a laptop, desktop, tablet, electronic pad, personal digital assistant, smart phone, television, kiosk, or portable computer.

The auction server 150 is illustrated as a single server, but may be implemented as several distinct servers working cooperatively. The auction server 150 may include a web server hosting an online auction website and back-end server managing the data required for the website. The auction server 150 interacts with one or more user devices 170, enabling the users to create auctions, place bids on auctions, and maintain information related to auctions. In some embodiments, users establish an account with the auction website. The auction server 150 manages such accounts and enables users to maintain account data. In some embodiments, different accounts have different privileges. For example, some accounts may have a VIP status. In some embodiments, an account has an associated level, where higher levels allow the account holder or user to access additional features. For example, a VIP or high level account may allow the user to create or access restricted auctions, to collect additional awards, to collect awards at a faster pace, to earn credit, or to be eligible various discounts.

The user devices 170 may include any device capable of accessing the auction server 150 via the network 110. Example user devices 170 include a desktop computer 170a, a laptop or personal computer 170b, or a mobile device 170c, such as a tablet, an electronic pad, a personal digital assistant, or a smart phone. Other example user devices 170 include a kiosk, a television, or a gaming system. Generally, the user devices 170 include a display element, however this is not required. The user devices 170 present an interface for the auction server 150 to a user. For example, in some embodiments, the user accesses features of an auction using a web browser running on the user device.

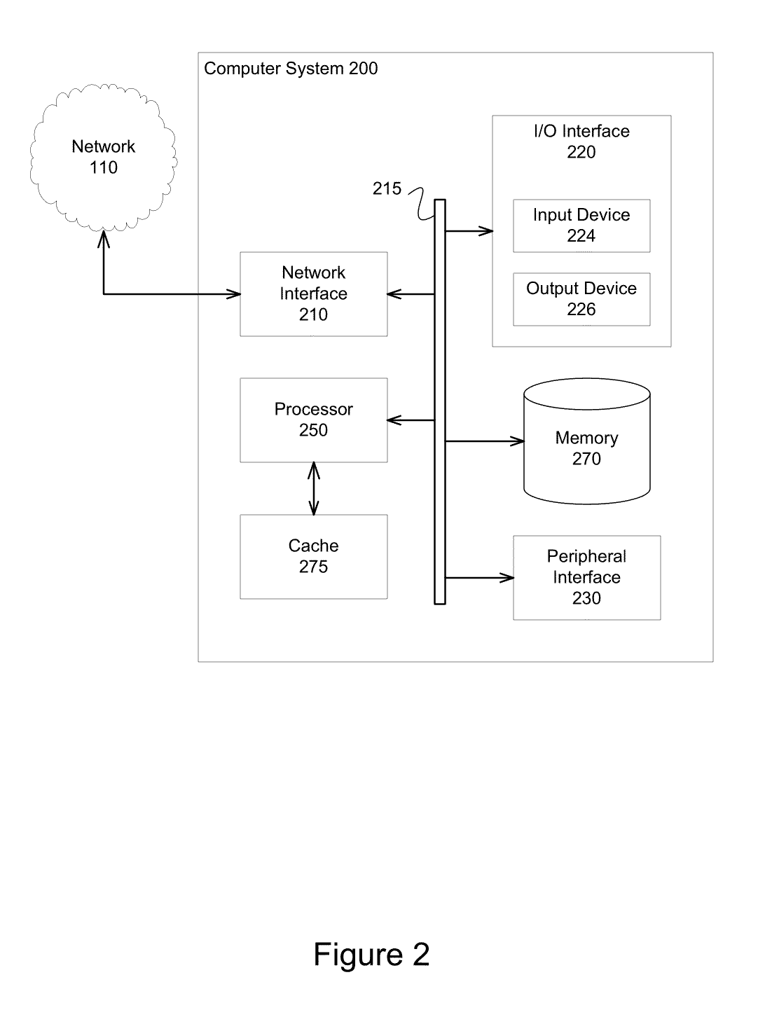

FIG. 2 illustrates an example computer system 200 suitable for use in implementing the computerized components of the system 100. The example computer system 200 includes one or more processors 250 in communication, via a bus 215, with one or more network interfaces 210 (in communication with the network 110), I/O interfaces 220 (for interacting with a user or administrator), and memory 270. The processor 250 incorporates, or is directly connected to, additional cache memory 275. In some uses, additional components are in communication with the computer system 200 via a peripheral interface 230. In some uses, such as in a server context, there is no I/O interface 220, or the I/O interface 220 is not used.

In some embodiments, the user devices 170 illustrated in FIG. 1 are constructed to be similar to the computer system 200 of FIG. 2. For example, a user interacts with an input device 224, e.g., a keyboard, mouse, or touch screen, to access an auction, e.g., via a web page, over the network 110. The interaction is received at the user's device's interface 210, and responses are output via output device 226, e.g., a display, screen, touch screen, or speakers. The output may be comprised of a mix of data received from the auction server 150 and from other systems.

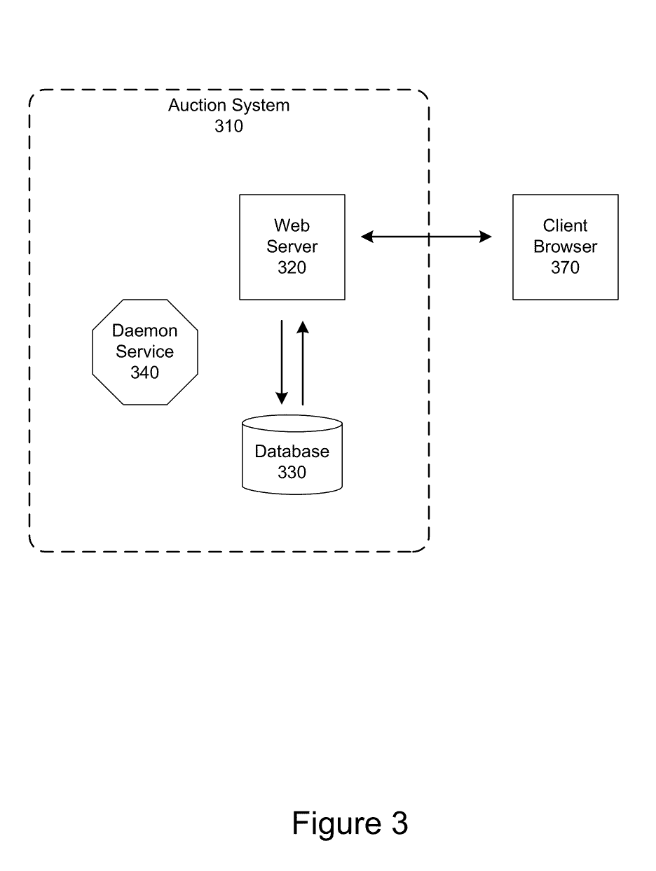

FIG. 3 illustrates example system for hosting an auction. The auction server 150 illustrated in FIG. 1 may comprise an auction system 310. The auction system 310 illustrated includes a web server 320, a database 330, and a daemon service 340. The web server 320 communicates with a client browser 370, e.g., over a network 110. The communication between the web server 320 and the client browser 370 may use the hypertext transport protocol (HTTP). In some embodiments, the communication includes AJAX calls. In some embodiments, the communication relies on Java, Javascript, Perl, Ruby, Ruby on Rails, or Flash. The auction system 310 may be unified or distributed.

The web server 320 is illustrated as a single server, but may be implemented as multiple servers working cooperatively. The web server may be implemented using one or more computers 200. The web server may host the entire auction system 310 or may rely on additional back end servers. For example, the daemon service 340 may run on a separate server. The web server 320 interacts with a persistent storage system, e.g., a database 330. The storage may be internal or external to the web server 320. For example, the web server 320 may access the database 330 via a network 110.

The database 330 maintains data related to the auctions and to the users of the auction system 310. For example, for any one auction, the database may record one or more of an auction identifier, a bid value for the highest bid, a bidder identifier for the highest bid, a time stamp for the current benchmark, a time stamp for the current time, a time stamp for a previous bid, a vector of bid values, a vector of bidder identifiers, a vector of bid times. The database may be a relational database. The database may use cloud-based storage. The database may use a data warehouse.

The daemon service 340 monitors the status of bids within the auction system 310. For example, in some embodiments, the daemon service 340 calculates the difference between a time stamp for a current bid placed and a time stamp for a previous bid placed. The daemon service 340 may be running on the web server 320, on the database 330, or on another server. The daemon service 340 may access the database 330 directly or the daemon service 340 may rely on a persistence layer between the daemon service 340 and the database 330. For example, in some embodiments, the daemon service 340 only communicates with the web server 320 and relies on the web server 320 to provide needed data.

In some embodiments, the daemon service 340 may periodically check the bidder id for the highest bid and the value of the highest bid on each active auction. The daemon service 340 can then calculate the increments by each bidder within a price range. In some embodiments, the period may be twice per second. The web server 320 may access the daemon service 340 to determine the sum of increments within a price range in an active auction and provide that information to a user, e.g., via the client browser 370.

The client browser 370 runs on a user device 170. For example, a web browser running on a laptop 370b or mobile device 370c may function as a client browser 370. In some embodiments, a user interacts with the auction system 310 using the client browsers 370. The user may be able to see active and recently closed auctions, account status information, and bids placed, using the client browser 370.

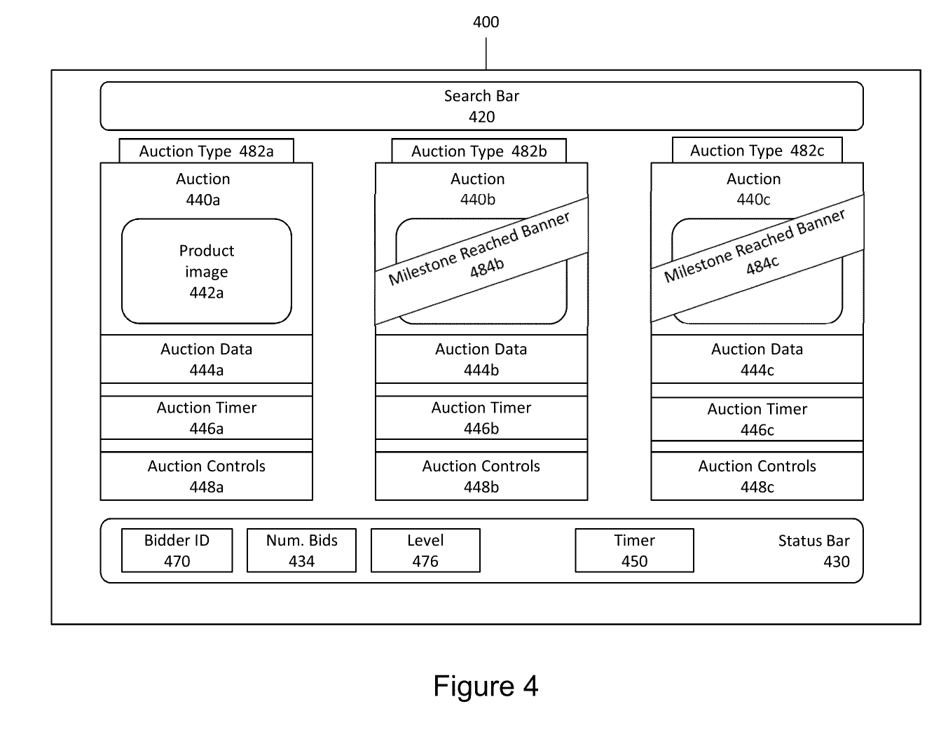

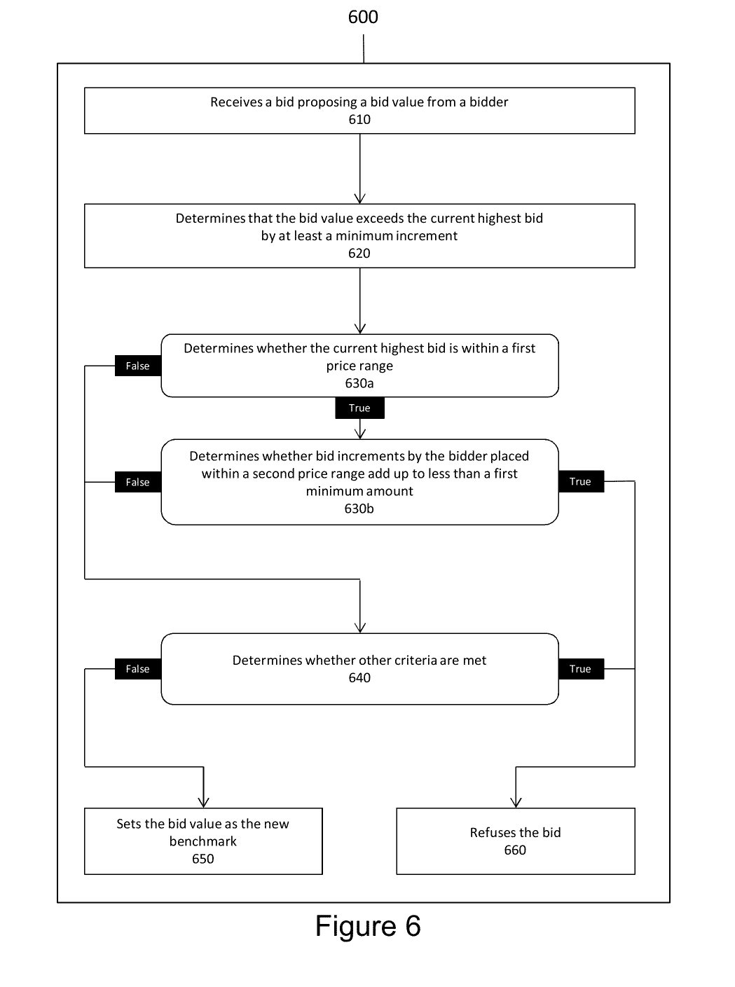

FIG. 4 illustrates an example user interface 400 as may be seen in a client browser 370 on a user device 170. The illustrated example interface 400 includes a search bar 420, a status bar 430, and multiple auctions 440a-n. Each of the auctions 440a-n is represented with a product image 441a-n, auction data 442a-n, an auction timer 443a-n, and auction controls 444a-n. In some embodiments, simple “No Jumper” auctions, illustrated in FIG. 6 as example auction 610a, where entry to the auction is denied to all new bidders after the highest current bid value reaches a milestone, may be indicated by banners like 482b and 482c as in auctions 440b and 440c. Reaching the milestone may be indicated by a “No New Bidders!” banner, as 484c in auction 440c. The status bar includes a timer 450, a bidder identifier 470 for the user, a level 476 for the bidder identifier 470, and a number of bids 434 for the bidder identifier 470.

The interface 400 is, in some embodiments, a web page with a number of elements. The elements may be updated without refreshing the web page, using, for example, AJAX, Javascript, or Flash. Each of the auctions 440a-n may be updated independently of the other auctions. For example, a first auction 440a may be updated independently of the remaining auctions 440b-n. While the elements of the interface 400 are illustrated in one configuration, the elements may be presented in other configurations. In some embodiments, different elements are presented. The illustration of FIG. 4 is provided as an example of an interface and is not meant to be limiting.

The search bar 420 provides a user with the ability to search the active and recently closed auctions. The user may enter search terms into the search bar and cause the display to show relevant auctions. In some embodiments, the search bar may be used to find information about the auction sellers and bidders. In some embodiments, the search bar may be used to find information about the incentives and awards. The status bar 430 provides the user with information about the user's bidding account. In some embodiments, a user of the auction system registers a bidding account with a bidder identifier 470. The status bar 430 displays the user's bidder identifier 470 and information about the bidding account including, for example, a level 476 and a number of bids 434. The status bar 430 also displays one or more timers 450. The number of bids 434 indicates to the user how many bids placed using the bidding account are currently active. In some embodiments, a bid must be the highest bid in the particular auction bid upon in order to be considered active. The bidding identifier 470 is illustrated as displayed in the status bar 430. It is not necessary to display the bidding identifier 470. In some embodiments, the auction system allows guest visitors or for a user to have multiple accounts. Displaying the bidding identifier 470 informs the user that they are logged in under an account by this name.

Each of the auctions 440a-n is represented with a product image 442a-n, auction data 444a-n, an auction timer 446a-n, and auction controls 448a-n. Each auction 440 is has a creator, a minimum bid, and an end time. Generally, the end time is established by the auction creator. In some embodiments, the end time increases with bid activity. For example, each bid adds a number of seconds to the end time. The number of seconds may vary based on an anticipated value for the offer or based on the actual length of time the auction has been active. In some embodiments, the number of seconds added for each additional bid is displayed next to the auction timers 446a-n.

The product images 442a-n are generally descriptions, pictures, logos, or trademarks associated with the auction offer. The product images 442a-n inform the bidder as to the auction offer. In some embodiments, a banner may be placed across the image, as illustrated with product image 442d, to demonstrate a restriction. The auction may be closed, the auction may be active but restricted to bidders above a certain level, or the auction may be active but restricted to bidders already participating in the auction. Restrictions on an auction may be indicated by icons anywhere on, in, or near the auction 440a-n. Restrictions may be indicated, for example, with an image of a padlock or by text in an adjacent tab. The product images 442a-n may be provided by third parties.

The auction data 444a-n specifies the current benchmark and the bidder account name for the highest bid. In some embodiments, the auction data 444a-n includes a retail price for the offer. A bidder can purchase the offer for the retail price without having to win the auction. In some embodiments, the auction data 444a-n indicates how long the highest bidder has been the highest bidder.

The auction timers 446a-n indicate the time remaining until the end time for each auction. In some embodiments, a second timer next to the time-remaining timer indicates an amount of time that will be added to the time remaining for each bid. When the time-remaining timer reaches zero, the auction ends. This is a terminating event for the auction. In some embodiments, an auction may also be terminated by an administrator for the auction website, e.g., to prevent fraud, or by the seller, e.g., because the offer is no longer available.

The auction controls 448a-n provide an interface for the user to place bids. In some embodiments, each bidding event increases the auction price by a penny (“Penny Auction”) and the bidder pays a separate fee for each bid. In some embodiments, the user enters a bid amount. In some embodiments, the user is presented with an immediate purchase opportunity. The user may elect to pay a retail price for the offer. The opportunity may persist even after the auction has ended, if, for example, the auction was for multiple instances of the offer. In some embodiments, the color of auction controls 448a-n may indicate whether the user is allowed to place a bid or not. In some embodiments, a number of criteria may have been established for refusing a bid and a bid may be refused if at least one of them is met. In such auctions, one color of auction controls may indicate that no criterion is met and, thus, a bid would be accepted if placed. Another color may indicate that at least one criterion is met and, thus, a bid would be refused if placed.

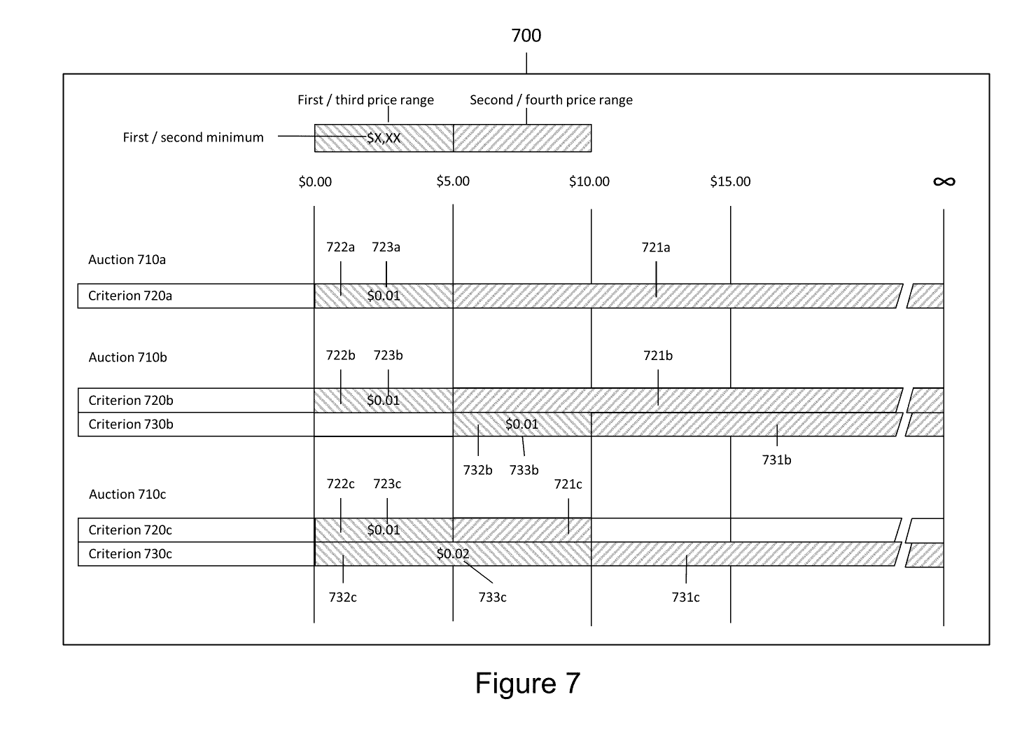

Auction Type banners 482a-n may, in some embodiments, indicate which criteria for refusing a bid are used in the auction. The banner may indicate, for example, a simple “No Jumper” type penny auction, illustrated in FIG. 7 as example auction 710a, where entry to the auction is denied to all new bidders after the highest current bid value reaches a certain milestone.

Milestone Reached Banners 484a-n may, in some embodiments, indicate to the user that the current benchmark has reached a certain milestone value. In some embodiments, a number of criteria may have been established for refusing a bid. One of the criteria may be two-part: i) the current benchmark has to be within a first price range, and ii) bid increments by the bidder placed within a second price range have to add up to less than a minimum amount. In such auctions, the milestone referred to by the banner may be, for example, the lower bound of the second price range referred to by such a criterion. The banner may indicate, for example that the milestone, after which new bidders may not anymore enter a “No Jumper” type auction, illustrated in FIG. 7 as example auction 710a, has been reached in the auction. The milestone has been reached in auction 440c but not in auction 440b.

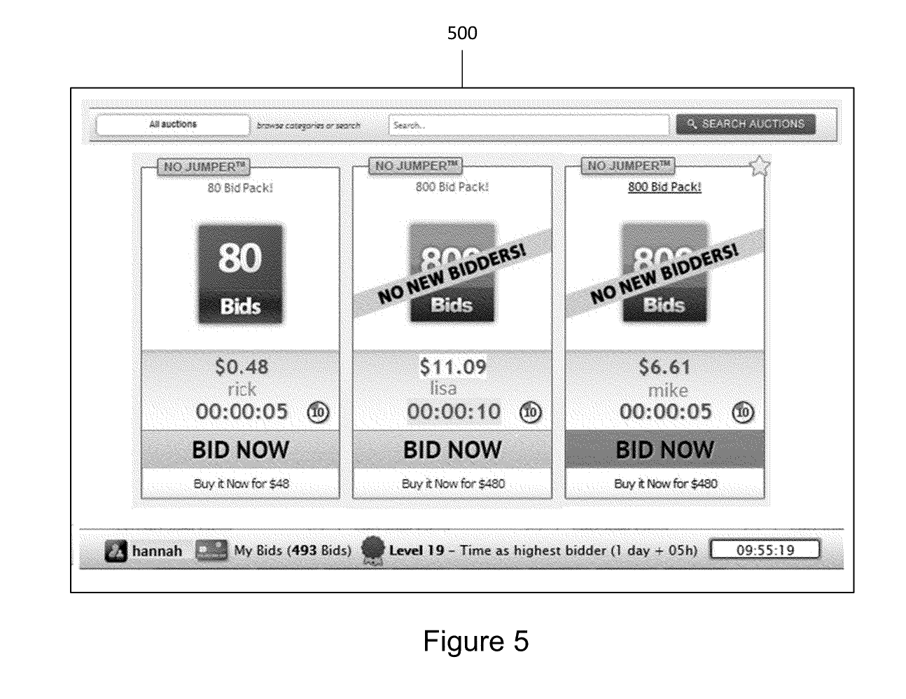

Referring to FIG. 5, the screenshot 500 illustrates a screenshot of a user interface corresponding to that of FIG. 4. While the elements of the interface 400 are illustrated in one configuration, the elements may be presented in other configurations. In some embodiments, different elements are presented. The illustration of FIG. 5 is provided as an example of an interface and is not meant to be limiting.

In both the middle auction, corresponding to auction 440b, and the right hand side auction, corresponding to auction 440c, the “No New Bidders!” banners, corresponding to the Milestone Reached Banners 484b and 484c, indicate that the milestone of a simple “No Jumper” type auction, illustrated in FIG. 7 as the example auction 710a, has been reached. In the middle auction the “Bid Now” button, corresponding to the auction control 448b, is yellow, indicating that the user is allowed to bid. In the right hand side auction the “Bid Now” button, corresponding to the auction control 448c, is brown, indicating that the user is not allowed to bid.

Referring to FIG. 6, a flowchart 600 illustrates a method for determining whether a bid is to be accepted or refused. In some embodiments, a number of criteria may be established for refusing a bid. In some embodiments, if at least one criterion is met, a bid may be refused. The illustration of FIG. 6 is provided as an example and is not meant to be limiting. Generally, at step 610, the auction server 150 receives a bid proposing a bid value from a bidder. At step 620, the auction server 150 determines that the bid value exceeds the current benchmark by at least a minimum increment. At consecutive steps 630a and 630b, the auction server 150 tests a two-part criterion established for refusing a bid: i) the current benchmark has to be within a first price range, and ii) bid increments by the bidder placed within a second price range have to add up to less than a first minimum amount. At step 630a, the auction server 150 determines whether the current benchmark is within the first price range. If this is false, the auction server 150 moves on to step 640. If this is true, the auction server moves on to step 630b. At step 630b, the auction server 150 determines whether bid increments by the bidder placed within a second price range add up to less than a first minimum amount. If this is false, the auction server 150 moves on to step 640. If this is true, the auction server moves on to step 660. At step 640, the auction server 150 determines whether at least one of the other criteria is met. If this is false, the auction server moves on to step 650. If this is true, the auction server 150 moves on to step 660. At step 650, the auction server 150 sets the bid value as the new benchmark. At step 660, the auction server 150 refuses the bid.

At step 610, an auction server 150 receives a bid proposing a bid value from a bidder. The bid value may be an incremental increase over a previous bid value. For example, in a penny auction system, each bid is a penny—but the bid value is the sum of the previous bids plus the additional penny for the new bid. That is, the bid value is the total bid proposed by the bidder. In some embodiments, the auction server 150 records the bid, an identifier for the bidder, the bid value, a timestamp for the bid time, and any other relevant data, in a database, e.g., the database 330 illustrated in FIG. 3. In some embodiments, the bid is added to a log or vector of bids stored for the auction. In some embodiments, only a bid establishing a new benchmark is recorded. Responsive to receiving the bid, the auction server 150 may provide confirmation to the bidder that the bid was received. For example, the auction display may update to reflect the new bid.

At step 620, the auction server 150 determines that the bid value exceeds the current benchmark by at least a minimum increment. Generally, only a bid proposing a bid value exceeding the current benchmark would be considered a relevant bid. In most auctions, the winner is the highest bid. The benchmark then is the highest bid received so far. At the beginning of the auction, the benchmark may be zero or some reserve price that must be met. In some auctions, the winner is the lowest bid. The benchmark then is the lowest bid received so far. At the beginning of the auction, the benchmark may be an initial bid or a value representing infinity. The superlative bid is the best bid.

At steps 630a and 630b, the auction server 150 tests a two-part criterion established for refusing a bid: i) the current benchmark has to be within a first price range, and ii) bid increments by the bidder placed within a second price range have to add up to less than a first minimum amount.

At step 630a, the auction server 150 determines whether the current benchmark is within the first price range.

If the current benchmark is not within the first price range, the auction server 150 moves on to step 640. If the current benchmark is within the first price range, the auction server moves on to step 630b.

At step 630b, the auction server 150 determines whether bid increments by the bidder placed within a second price range add up to less than a first minimum amount.

If bid increments by the bidder placed within a second price range add up to at least the first minimum amount, the auction server 150 moves on to step 640. If bid increments by the bidder placed within a second price range add up to less than the first minimum amount, the auction server moves on to step 660.

At step 640, the auction server 150 determines whether any one of the other criteria is met. Among the other criteria, there may be, in some embodiments, a second two-part criterion: i) the current benchmark has to be within a third price range, and ii) bid increments by the bidder placed within a fourth price range have to add up to less than a second minimum amount. There may be a third and a fourth similar two-part criterion, as well. The second, third and fourth such criteria may be tested with the same procedure as the first such criterion was tested with at steps 630a and 630b.

If there are no other criteria or none of them is met, the auction server moves on to step 650. If at least one of the other criteria is met, the auction server moves on to step 660.

At step 650, the auction server 150 sets the bid value as the new benchmark. Each new bid is expected to exceed the previous benchmark. This may be tracked by setting the benchmark value to the new bid value. In some embodiments, a pointer to the best bid is set, instead of maintaining the value separately. In some embodiments, only the best bid is recorded and setting the benchmark is a matter of updating the bid record for the best bid.

At step 660, the auction server 150 refuses the bid. The bid is not recorded as an increment.

Referring to FIG. 7, the chart 700 illustrates three possible criteria for refusing a bid. The illustration of FIG. 7 is provided as an example and is not meant to be limiting. The values are exemplary.

In example auction 710a, a simple “No Jumper” auction, there is only one criterion, 720a. Based on criterion 720a, a bid is refused if both i) the current benchmark lies within price range 721a, i.e. its value is equal or greater than $5.00, and ii) bid increments by the bidder placed price range 722a, that is, between $0.00 and $5.00, add up to less than $0.01. Criterion 720a, thus, requires that bid increments by the bidder before the milestone of $5.00 add up to at least $0.01 in order that the bidder is allowed to continue bidding beyond the milestone. In a penny auction, criterion 720a and criteria like it simply mean that after the milestone bidding is allowed for a bidder only if the bidder has bid before the milestone at all. Criterion 720a and criteria like it, thus, incentivize early bidding.

In example auction 710b, there are two criteria, 720b and 720b. Based on criterion 720b, a bid is refused if both i) the current benchmark is within price range 721b, i.e. its value is equal or greater than $5.00, and ii) bid increments by the bidder placed price range 722b, i.e. between $0.00 and $5.00, add up to less than the minimum amount 723b, $0.01. Based on criterion 730b, a bid is refused if both i) the current benchmark is within price range 731b, i.e. its value is equal or greater than $10.00, and ii) bid increments by the bidder placed price range 732b, i.e. between $5.00 and $10.00, add up to less than the minimum amount 733b, $0.01. Criteria 720b and 730b, thus, require that a bidder's bid increments within previous $5.00 before each milestone add up to at least $0.01 in order that the bidder is allowed to continue bidding beyond that milestone. In a penny auction, criterion 720a and criteria like it simply mean that a bidder is required to bid within each price range, between two milestones. The set of criteria 720b and 730b and sets of criteria like it, thus, incentivize continuous bidding.

In example auction 710c, there are two criteria, 720c and 720c. Based on criterion 720c, a bid is refused if both i) the current benchmark is within price range 721c, i.e. its value is equal or greater than $5.00 but less than $10.00, and ii) bid increments by the bidder placed price range 722c, i.e. between $0.00 and $5.00, add up to less than the minimum amount 723c, $0.01. Based on criterion 730c, a bid is refused if both i) the current benchmark is within price range 731c, i.e. its value is equal or greater than $10.00, and ii) bid increments by the bidder placed price range 732c, i.e. between $0.00 and $10.00, add up to less than the minimum amount 733c, $0.02. Criteria 720c and 730c, thus, require that a bidder's bid increments before each milestone, $5.00 and $10.00 add up to at least minimum amounts, which increase with the value of the milestone, in order that the bidder is allowed to continue bidding beyond that milestone. The set of criteria 720a and 720b and sets of criteria like it, thus, incentivize continuous bidding.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer-readable storage media for execution by, or to control the operation of, data processing apparatus. The program instructions can be encoded on an artificially generated propagated signal, e.g., a machine-generated electrical, optical, or electromagnetic signal that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially generated propagated signal. The computer-readable storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The auction server 150 or auction system 310 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a LCD (liquid crystal display) monitor, LED or OLED screen, a CRT (cathode ray tube), a plasma screen, or a projector, for displaying information to the user and a touch screen, keyboard, or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an embodiment of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 310 can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements. References to “or” may be construed as inclusive so that any terms described using “or” may indicate any of a single, more than one, and all of the described terms.

Thus, particular embodiments of the subject matter have been described. Other embodiments are within the scope of the following claims.

What is claimed is:

1. A method of hosting an auction, the auction having, for each specified time within an active timeframe of the auction, a current highest bid value, the method comprising:
receiving, from a first bidder, at a first time within the active timeframe of the auction, a first bid having a first bid value;
evaluating the first bid to:
a) determine that the first bid value exceeds the current highest bid value of the auction corresponding to the first time by at least a first minimum increment;
b) determine that the first bid value is within a first price range;
c) determine that the first bidder has placed at least one previous bid at an earlier time within the active timeframe of the auction, such that the at least one previous bid caused the current highest bid value to be increased by at least a first minimum total amount; and
replacing the current highest bid value with the value of the first bid received from the first bidder.

2. The method of claim 1, further comprising:
receiving, from a second bidder, at a second time within the active timeframe of the auction and after the first time, a second bid have a second bid value;
evaluating the second bid to:
d) determine that the second bid value exceeds the current highest bid value of the auction corresponding to the second time by at least a second minimum increment;
e) determine that the second bid value is within a second price range;
f) determine that the second bidder has placed at least one previous bid at an earlier time within the active timeframe of the auction, such that the at least one previous bid caused the current highest bid value to be increased by at least a second minimum total amount; and
replacing the current highest bid value with the value of the second bid received from the second bidder.

3. The method of claim 2, wherein the first bidder is the second bidder.

4. The method of claim 2, wherein the first bidder is not the second bidder.

5. The method of claim 1, further comprising:
terminating the auction before receiving another bid from another bidder;
and charging the last bidder the bid value.

6. The method of claim 1, wherein the bid value is a previous bid value plus an incremental value over the previous bid value.

7. A system for hosting an auction, the system comprising:
an auction server comprising at least one physical processor, the auction server configured to:
receive, from a first bidder, at a first time within the active timeframe of the auction, a first bid having a first bid value;
evaluate the first bid to:
a) determine that the first bid value exceeds the current highest bid value of the auction corresponding to the first time by at least a first minimum increment;
b) determine that the first bid value is within a first price range;
c) determine that the first bidder has placed at least one previous bid at an earlier time within the active timeframe of the auction, such that the at least one previous bid caused the current highest bid value to be increased by at least a first minimum total amount; and
replace the current highest bid value with the value of the first bid received from the first bidder.

8. The system of claim 7, wherein the auction server is further configured to:
receive, from a second bidder, at a second time within the active timeframe of the auction and after the first time, a second bid have a second bid value;
evaluate the second bid to:
d) determine that the second bid value exceeds the current highest bid value of the auction corresponding to the second time by at least a second minimum increment;
e) determine that the second bid value is within a second price range;
f) determine that the second bidder has placed at least one previous bid at an earlier time within the active timeframe of the auction, such that the at least one previous bid caused the current highest bid value to be increased by at least a second minimum total amount; and
replace the current highest bid value with the value of the second bid received from the second bidder.

9. The method of claim 8, wherein the first bidder is the second bidder.

10. The method of claim 8, wherein the first bidder is not the second bidder.

11. The system of claim 8, wherein the auction server is further configured to:
terminate the auction before receiving another bid from another bidder;
and charge the last bidder the bid value.

12. The system of claim 8, wherein the bid value is a previous bid value plus an incremental value over the previous bid value.

13. The system of claim 8, wherein the auction server is further configured to:
display, via an auction website, that the current highest bid value is within the first price range.

14. The system of claim 8, wherein the auction server is further configured to:
display, via the auction website, to a bidder, that the bidder has not placed previous bids such that the previous bids caused the current highest bid value to be increased by at least the first minimum total amount.

15. A non-transitory computer readable medium encoded with instructions that, when executed on a processing unit, perform a method, the method comprising:
receiving, from a first bidder, at a first time within the active timeframe of the auction, a first bid having a first bid value;
evaluating the first bid to:
a) determine that the first bid value exceeds the current highest bid value of the auction corresponding to the first time by at least a first minimum increment;
b) determine that the first bid value is within a first price range;
c) determine that the first bidder has placed at least one previous bid at an earlier time within the active timeframe of the auction, such that the at least one previous bid caused the current highest bid value to be increased by at least a first minimum total amount; and
replacing the current highest bid value with the value of the first bid received from the first bidder.

16. The computer readable medium of claim 15, wherein the method further comprises:
receiving, from a second bidder, at a second time within the active timeframe of the auction and after the first time, a second bid have a second bid value;
evaluating the second bid to:
d) determine that the second bid value exceeds the current highest bid value of the auction corresponding to the second time by at least a second minimum increment;
e) determine that the second bid value is within a second price range;
f) determine that the second bidder has placed at least one previous bid at an earlier time within the active timeframe of the auction, such that the at least one previous bid caused the current highest bid value to be increased by at least a second minimum total amount; and
replacing the current highest bid value with the value of the second bid received from the second bidder.

17. The computer readable medium of claim 15, wherein the first bidder is the second bidder.

18. The computer readable medium of claim 15, wherein the first bidder is not the second bidder.

19. The computer readable medium of claim 15, wherein the method further comprises:
terminating the auction before receiving another bid from another bidder;
and charging the last bidder the bid value.

20. The computer readable medium of claim 15, wherein the bid value is a previous bid value plus an incremental value over the previous bid value.
